(19) United States
(12) Patent Application Publication
(10) Pub. No.: US 2026/0159325 A1
(43) Pub. Date: Jun. 11, 2026

(54) A CONVEYOR CHAIN FOR CONVEYING MATERIAL

(71) Applicant: Omya International AG, Oftringen (CH)

(72) Inventor: Eugenio Rodolfo MATTIONI, Courcelon (CH)

(73) Assignee: Omya International AG, Oftringen (CH)

(21) Appl. No.: 18/706,053

(22) PCT Filed: Nov. 3, 2022
(86) PCT No.: PCT/EP2022/080701

§ 371 Date: Apr. 30, 2024

(30) Foreign Application Priority Data
Nov. 15, 2021 (EP) 21208323.2

(51) Int. Cl. B65G 17/38; B65G 19/14; B65G 19/24

(52) U.S. Cl. CPC B65G 17/385; B65G 19/14; B65G 19/24; B65G 2201/042

(57) ABSTRACT

A conveyor chain for conveying material, comprising: a joint element with a first interface and a second interface; a first chain element configured to be connected with the first interface of the joint element; a second chain element configured to be connected with the second interface of the joint element; wherein the first interface provides a first pivoting degree of freedom in one direction and the second interface provides a second pivoting degree of freedom in a second direction, wherein the second direction is different from the first direction; at least one conveying element for conveying material arranged in the region of the joint element.

### TECHNICAL FIELD

The present invention relates to a conveyor chain for conveying material, to a system for conveying a material, to a use of a joint element with a first interface and a second interface, and to a use of an electro mechanical drive unit or a hydraulic drive unit for driving such a conveyor chain in such a conveyor system.

### TECHNICAL BACKGROUND

In process engineering, materials are conveyed over long distances within a site or between two or more sites of a plant for further processing. In case of liquid materials or gaseous materials, pressure-based conveying systems are used. Fine powders are transported, for long distance, in a pneumatic way with a low or high-pressure system. In case of solid and/or dry materials (e.g. pellets), conveyor chains are used among others. Conveyor chains for solid and/or dry materials are known in the state of the art and widely used. The performance of such a conveyor chain affects the design of a site of a plant and of the plant and a performance of such a site and of such a plant.

It has been found that a further need exists to improve such a conveyor chain for conveying material.

### SUMMARY OF INVENTION

It is an object of the present invention to provide an improved conveyor chain for conveying material, in particular to provide a reliable, flexible and cost efficient conveyor chain for conveying material.

According to a first aspect of the present invention, a conveyor chain for conveying material is provided, comprising: a joint element with a first interface and a second interface; a first chain element configured to be connected with the first interface of the joint element; a second chain element configured to be connected with the second interface of the joint element; wherein the first interface provides a first pivoting degree of freedom in one direction and the second interface provides a second pivoting degree of freedom in a second direction, wherein the second direction is different from the first direction; at least one conveying element for conveying material arranged in the region of the joint element.

The term material, as used herein, is to be understood broadly and relates to any solid and/or dry material. The material may have any shape, e.g. a spherical shape, a square shape, a freeform shape. The material have different sizes. The material may have different weights. The material may be an organic material. The material may be an inorganic material. The material may be for example a metal (e.g. aluminum), a sand (e.g. quartz sand), a plastic (e.g. Polyethylene pellets), a dried plant (e.g. sugar beets), a dry and a wet calcium carbonate, a dry and a wet dolomite, a dry and a wet gypsum, a clay, a marl, an organic and an inorganic additive, a boron, a selenium, a calcium hydroxide, a salt, a seaweed, a lignosulphonate and a dextrin.

The term joint element, as used herein, is to be understood broadly and relates to any structural element configured to connect physically a first chain element with a second chain element. The joint element may consist of any material configured to provide a strength to withstand loads during conveying material. The joint element may consist of a metal (e.g. structural steel), a plastic, or a reinforced plastic. The joint element may be a single element or may comprise several elements. The joint may be a single element consisting of a metal. The joint element may have different sizes. The term interface, as used herein, is to be understood broadly, and relates any mechanical interface configured to connect mechanically a joint element with a chain element.

The term chain element, as used herein, is to be understood broadly and relates to any chain element configured to be connected with a joint element and to bear loads. The chain element may consist of a metal, a plastic, or a reinforced plastic. The first chain element and second chain element may be equal or different. Preferably, the first chain element and second chain element are equal. The chain element may comprise a single element or several elements. The chain element can be made of 18NICrMo5.

The term pivoting degree of freedom, as used herein, means in the present case a pivoting degree of freedom between a chain element and a joint element. The pivoting degree of freedom may comprise any pivoting angle between 0° and approximately 360°. The pivoting degree of freedom may comprise preferably a pivoting angle of between 0° and approximately 180°. The direction, as used herein, means a direction of a degree of freedom, in particular of a pivoting degree of freedom. The first direction and the second direction may differ by any angle, preferably by a 90° angle. In other words, in a right-angled coordinate system, one pivoting angle may be for example around an x-axis and a second pivoting angle may be for example around the y-axis. The term conveying element, as used herein, is to be understood broadly and relates to any to structural element configured to transport material. The conveying element may comprise a single element or may comprises several elements. The conveying element may consist of metal, plastic or a combination thereof. The conveying element may comprise any shape. The conveying element preferably comprises a shape configured to fit to a conveying tube shape such that a material within in the conveying tube can be conveyed. The conveying element may comprise a round shape. The conveying element may be a disc.

In other words, the invention is based on the knowledge that conveyor chains in conveyor tubes for conveying material are subject to several problems such as high friction, tilting of chain element and/or material, reduced free conveyor chain length (horizontal and vertical), reduced material load due to round link chain design, high energy demand due to friction, conveyor failures due to tiling of chain elements and/or material, increased wear due to friction, high process and maintenance costs for the conveying system. The disclosed conveyor chain proposes to solve these problems by providing a joint element comprising two interfaces, wherein each interface has one pivoting degree of freedom different from the other one. The proposed conveyor chain enables deviating of the conveyor chain in two directions (horizontal and vertical). This enables advantageously a reliable guiding of the conveyor chain through the conveyor tube as tilting of chain elements and/or material is prevented and friction is reduced. The arrangement of the conveying element on the joint element reduces advantageously the tendency of tilting of the chain elements and/or material as the movability of the conveyor chain increases. The proposed conveyor chain leads advantageously to a reduced friction, a reduced wear, reduced energy consumption, reduced process and maintenance costs. The proposed conveyor chain enables advantageously free conveyor chain lengths between two electro mechanical drive units up to 1000 m in a horizontal direction due to reduced friction and increased strength of the joint element. The proposed conveyer chain enables a flowrate of the material from 5 t/h to 42 t/h. The proposed conveyor chain enables advantageously a conveyor height difference between two levels up to 80 m due to reduced friction and increased strength of joint element. The proposed conveyor chain enables a reliable and clean material conveying. Due to its efficient design, only reduced capital expenditure is necessary. The proposed conveyor chain enables a high geometrical flexibility in relation to a possible path of the conveyor chain and is therefore easy to implement in already existing sites or plants.

In an embodiment, the at least one conveying element may be arranged rotatably in the region of the joint element. The conveying element and the joint element may comprise for example correspondingly high clearance fit in order to enable a rotation between conveying element and joint element. The conveying element may have a through hole and the joint element partly an approximate spherical shape. This may be advantageous in terms of friction reduction and reduction of a tilting tendency of the conveyor chain and/or the material.

In an embodiment, a conveyor chain is provided, wherein the first direction and the second direction differ by 90°. This may advantageously reduce a tilting tendency of the chain elements and/or the material.

In an embodiment, the first interface and the second interface may comprise each an opening, preferably a through hole, configured to bear a pin, preferable a screw, in order to be connected with the first chain element and the second chain element. The pin may be beared rotatably or rigidly. The opening and the pin may comprise a clearance fit, a transition fit or a press fit. The screw may comprise a corresponding screw nut and optionally a flat washer. This may enable a reliable connection between the chain elements and an increased strength of the joint element and of the connection between the joint element and the first chain element and second chain element.

In an embodiment, the first chain element and the second chain element may comprise each at least one opening configured to bear a pin, preferably a screw, in order to be connected with the joint element. This may enable to assemble reliably the first chain element and the second chain element with the joint element. The chain element may be a one-piece chain element and pushed over the opening of the interface of the joint element in order to put a pin through the chain element and the joint element for connecting them. The chain element may be a multi-piece chain element, wherein a first part of the chain element may be arranged on an upper surface of the opening of the interface of the joint element and a second part of the chain element may be arranged on a lower surface of the opening of the interface of the joint element. Preferably, the first chain element, the second chain element and any further chain element comprise at each end of its two ends such an opening.

In an embodiment, the first chain element and the second chain element may be arranged offset by an angle by means of the joint element with a linear alignment of the conveyor chain, wherein the angle is preferably 90°. In other words, the first chain element and the second chain element are arranged rotated by 90° to each in case the conveyor chain moves along a linear direction. This may be advantageous in terms geometrical flexibility of the conveyor chain and a reduced tilting tendency.

In an embodiment, the first chain element and/or the second chain element comprise an opening configured to be engaged with at least one drive element of an electro mechanical drive unit for driving the conveyor chain. The opening may be an open space between the two ends of the chain element. The drive element may be a tooth or a driver, which engages in the opening in order to move the conveyor chain and/or to redirect the conveyor chain. This may be an efficient way to drive and redirect the conveyor chain.

A further aspect of the present invention relates to a system for conveying a material, comprising: a conveyor chain as described above; a conveyor tube configured to house the conveyor chain and the conveyed material; at least one electro mechanical drive unit comprising a drive wheel and at least one drive element configured to be engaged with an opening of a chain element of the conveyor chain for driving the conveyor chain. The conveyor tube may consist of metal or plastic. The conveyor tube may be a straight pipe or a curved pipe. The conveyor tube and the conveyor chain may preferably have matched dimensions. The electro mechanical drive unit may comprise an AC motor, one or more gearboxes and a motor control connected to a superordinate control of the conveying system, the site, or the plant. The drive wheel may comprise one or more drive elements (e.g. a driver or a tooth) which are configured to engage with an opening of a chain element of the conveyor chain described above in order to drive the conveyor chain. The drive wheel may further redirect the conveyor chain in another direction. The conveyor tube may have an opening in a region where the drive element engages with conveyor chain. The region between the opening of the conveyor chain and the electro mechanical drive unit may be housed in order to prevent a leakage of the material.

In an embodiment, a length of the conveyor chain between two electro mechanical drive units may be between 100 m and 1000 m, preferably between Om and 200 m, more preferably between 500 m and 1000 m, most preferably between 750 m and 1000 m. This may advantageous as long distances with only two electro mechanical drive units between can be provided due to the proposed conveyor chain with a low friction, a reduced tendency of tilting and increased strength.

In an embodiment, a conveyor height difference between different levels of the system may be between Om and 80 m, preferably between 40 m and 80 mm, most preferably between 60 m and 80 m. This may advantageous as big height differences within a site can be realized due to the proposed conveyor chain with a reduced friction, a reduced tendency of tilting and increased strength.

In an embodiment, a breaking load of a material of the conveyor chain may be 100 kg/mm2 .

In an embodiment, a diameter of the conveyor tube may be between 100 and 350 mm, preferably between 200 and 350 mm, most preferably between 300 and 350 mm. The diameter of the conveyor tube depends on a flowrate of the material.

In an embodiment, a drive wheel of the electro mechanical drive unit may have diameter between 300 mm and 1000 mm, preferably between 350 and 450 mm, most preferably between 400 and 450 mm.

A further aspect of the present disclosure relates to a use of a joint element with a first interface and a second interface in a conveyor chain described above and/or in a system described above.

A last aspect of the present disclosure relates to a use of an electro mechanical drive unit or a hydraulic drive unit for driving a conveyor chain described above in a system described above.

### BRIEF DESCRIPTION OF THE DRAWINGS

In the following, the present disclosure is described exemplarily with reference to the enclosed figure, in which

FIG. 1 is a schematic view of a conveyor chain according to the preferred embodiment of the present disclosure;

FIG. 2 is a second schematic view of a conveyor chain according to the preferred embodiment;

FIG. 3 is a schematic view of a system according to an embodiment; and

FIG. 4 is a second schematic view of a system according to an embodiment.

### DETAILED DESCRIPTION OF EMBODIMENT

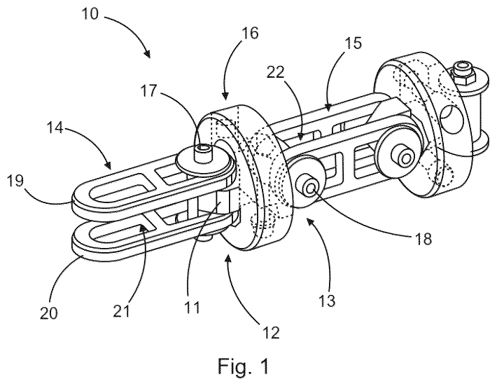

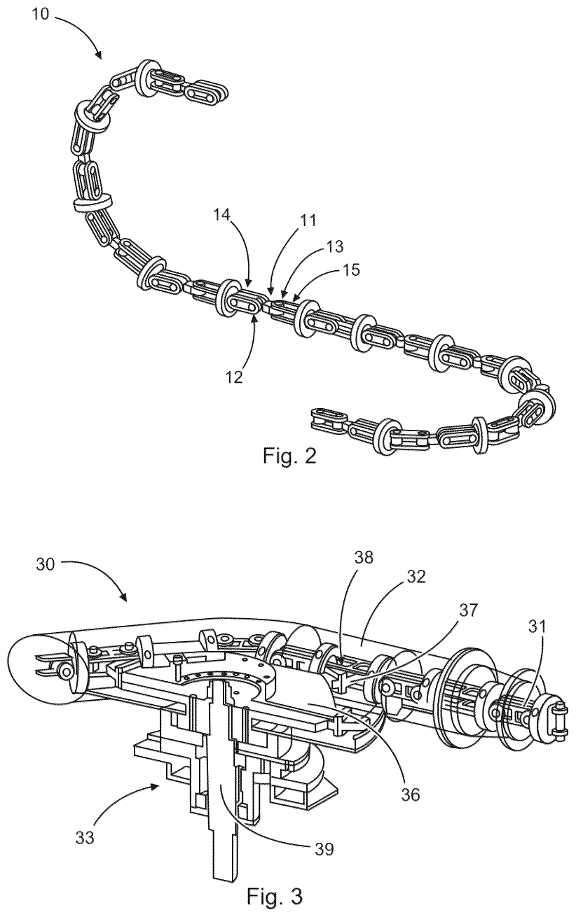

In the following FIG. 1 and FIG. 2 are described together with the same reference signs. FIG. 1 is a schematic view of a conveyor chain 10 according to the preferred embodiment of the present disclosure and FIG. 2 is a further schematic view of a conveyor chain according to preferred embodiment. The conveyor chain 10 is used for conveying material. The material is in the present example a metal granulate. The conveyor chain 10 comprises a joint element 11 with a first interface 12 and a second interface 13. The conveyor chain 10 comprises further a first chain element 14 configured to be connected with the first interface 12 of the joint element 11; and a second chain element 15 configured to be connected with the second interface 13 of the joint element 11; wherein the first interface 12 provides a first pivoting degree of freedom in one direction and the second interface provides a second pivoting degree of freedom in a second direction, wherein the second direction is different from the first direction. The first direction and the second direction differ in the present example by 90°. The conveyor chain 10 comprises further at least one conveying element 16 for conveying material arranged in the region of the joint element 11. The conveying element 16 is in the present example a disc. In FIG. 2 is in comparison to FIG. 1 only every second joint element 11 presented with a conveying element 16. It should be mentioned that this is for a better view on the joint element. However, this may also apply for other embodiments. The conveying element 16 is arranged rotatably around the joint element 11 by means of clearance fit between the joint element 11 and the conveying element 16. The conveyor chain 10 comprises a plurality of chain elements and joint elements, as can be seen in FIG. 2. The first interface 12 and the second interface 13 comprise each a through hole configured to bear a screw 17 and 18 in order to be connected with the first chain element 14 and the second chain element 15. The first chain element 14 and the second chain element 15 comprise each a through hole configured to bear each the screw 17 and 18. The first chain element 14 and the second chain element 15 are equal and arranged offset by an angle of 90° by means of the joint element 11. The chain element is in the present example a multi-piece chain element, wherein a first part 19 of the chain element is arranged on an upper surface of the opening of the interface of the joint element 11 and a second part 20 of the chain element is arranged on a lower surface of the opening of the interface of the joint element 11. The first chain element 14 and the second chain element 15 comprise an opening 21 and 22 configured to be engaged with at least one drive element of an electro mechanical drive unit for driving the conveyor chain.

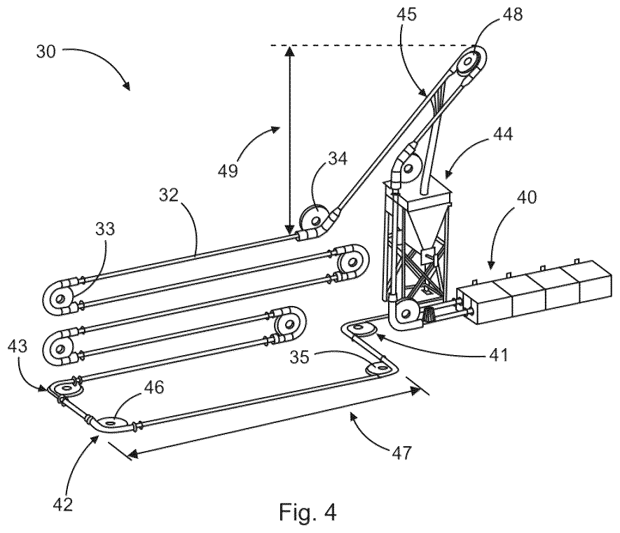

In the following FIG. 3 and FIG. 4 are described together with the same reference signs. FIG. 3 shows a schematic view of a system 30 for conveying material according to a preferred embodiment. FIG. 4 shows a second view of a system 30 according to an embodiment. The system 30 comprises a conveyor chain 31 as described above. The system 30 comprises further a conveyor tube 32 configured to house the conveyor chain 31 and the conveyed material. The system 30 comprises several electro mechanical drive units 33, 34, 35. The electro mechanical drive unit comprises a drive wheel 36 and at least one drive element 37 configured to be engaged with an opening 38 of a chain element of the conveyor chain 31 for driving the conveyor chain 31. The conveyor tube consists of metal. The electro mechanical drive unit comprises an AC motor, a gearbox connected to the AC motor, a shaft 39 that is connected with an output shaft of the gearbox. The drive wheel 36 is mounted on the shaft 39. The electro mechanical drive unit 33 comprises further a motor control connected to a superordinate control of the system. The superordinate control of the system is configured to control the material conveying.

The conveyor tube 32 has an opening in a region where the drive element 37 engages with conveyor chain 31. The region between the opening of the conveyor chain and the electro mechanical drive unit is housed in order to prevent a leakage of the conveyed material. In FIG. 4 a possible application is presented, wherein material is conveyed from a supply area 40 via several corners 41, 42 and 43, several distances, height differences and a junction 45 to a material processing unit 44. At the junction 45, the conveyed material falls into the material processing unit 44. The conveyor chain 31 runs further back to supply area 40 in order to receive new material for conveying. The present example shows a circulatory system. At the corners 41, 42 and 43 are each electro mechanical drive units arranged in order to drive the conveyor chain 31 and to redirect the conveyor chain 31. The free length 47 of the conveyor chain between two electro mechanical drive units 35 and 46 may be between 100 m and 1000 m. The conveyor height difference 49 (i.e. vertical length) between different levels of the system 30 is approximately 80 m. At the different levels, electro mechanical drive units 34 and 48 are arranged to drive the conveyor chain. In the present example, the breaking load of a material of the conveyor chain is 100 kg/mm2. The diameter of the conveyor tube 32 is in the present example 200 mm. The drive wheel 36 of the electro mechanical drive unit 33 has in the present example a diameter of 450 mm. The flow rate is approximately 10 t/h in the present example. The speed of the conveying chain is up to 0.345 m/s in the present example. The system 30 may further comprise one or more tensioning units configured to tension the conveyor chain.

The present disclosure has been described in conjunction with a preferred embodiment as examples as well. However, other variations can be understood and effected by those persons skilled in the art and practicing the claimed invention, from the studies of the drawings, this disclosure and the claims. In the claims as well as in the description the word “comprising” does not exclude other elements and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### REFERENCE SIGNS

10, 31 conveyor chain
11 joint element
12 first interface
13 second interface
14 first chain element
15 second chain element
16 conveying element
17, 18 screw
19,20 first part and second part of a chain element
21, 22, 38 opening
30 system
32 conveyor tube
33, 34, 35, 46, 48 electro mechanical drive unit
36 drive wheel
37 drive element
39 shaft for gear box connection
40 supply area
41, 42, 43 corners
44 material processing unit
45 junction
47 length between electro mechanical drive units
49 conveyor height between electro mechanical drive units

1. A conveyor chain for conveying material, comprising:
a joint element with a first interface and a second interface
a first chain element configured to be connected with the first interface of the joint element
a second chain element configured to be connected with the second interface of the joint element;
wherein the first interface provides a first pivoting degree of freedom in one direction and the second interface provides a second pivoting degree of freedom in a second direction, wherein the second direction is different from the first direction;
at least one conveying element for conveying material arranged in the region of the joint element.

2. The conveyor chain according to claim 1, wherein the at least one conveying element is arranged rotatably in the region of the joint element

3. The conveyor chain according to claim 1, wherein the first direction and the second direction differ by 90°.

4. The conveyor chain according to claim 1, wherein the first interface and the second interface comprise each an opening, preferably a through hole, configured to bear a pin, preferable a screw in order to be connected with the first chain element and the second chain element.

5. The conveyor chain according to claim 1, wherein the first chain element and the second chain element comprise each at least one opening configured to bear a pin, preferably a screw, in order to be connected with the joint element

6. The conveyor chain according to claim 1, wherein the first chain element and the second chain element are arranged offset by an angle by means of the joint element with a linear alignment of the conveyor chain wherein the angle is preferably 90°.

7. The conveyor chain according to claim 1, wherein the first chain element and/or the second chain element comprise an opening configured to be engaged with at least one drive element of an electro mechanical drive unit, for driving the conveyor chain.

8. A system for conveying a material, comprising:
a conveyor chain according to claim 1;
a conveyor tube configured to house the conveyor chain and the conveyed material;
at least one electro mechanical drive unit comprising a drive wheel and at least one drive element configured to be engaged with an opening of a chain element of the conveyor chain for driving the conveyor chain.

9. The system according to claim 8, wherein a length of the conveyor chain between two electro mechanical drive units is between 100 m and 1000 m, preferably between 500 m and 1000 m, most preferably between 750 m and 1000 m.

10. The system according to claim 8, wherein a conveyor height difference between different levels of the system is between 20 m and 80 m, preferably between 40 m and 80 mm, most preferably between 60 m and 80 m.

11. The system according to claim 8, wherein a breaking load of a material of the conveyor chain is 100 kg/mm².

12. The system according to claim 8, wherein a diameter of the conveyor tube is between 100 and 350 mm, preferably between 200 and 350 mm, most preferably between 300 and 350 mm.

13. The system according to claim 8, wherein a drive wheel of the electro mechanical drive unit has diameter between 300 and 1000 mm, preferably between 350 and 450 mm, most preferably between 400 and 450 mm.

14. (canceled)

15. (canceled)

16. A method of conveying material, the method comprising:
providing a conveyor chain for conveying material according to claim 1; and
conveying material with at least one conveying element of the conveyor chain.

17. A method of conveying material, the method comprising:
providing a system for conveyor material according to claim 8;
driving a conveyor chain of the system with at least one electro mechanical drive of the system; and
conveying material with at least one conveying element of the conveyor chain.

18. A method of conveying material, the method comprising:
providing a system for conveyor material according to claim 8;
driving a conveyor chain of the system with at least one hydraulic drive unit of the system; and
conveying material with at least one conveying element of the conveyor chain.
